(19) United States
(12) Patent Application Publication
(10) Pub. No.: US 2005/0210123 A1
(43) Pub. Date: Sep. 22, 2005

(54) System and method for graphically managing network devices

(75) Inventors: Jain-Chung Wang, Tu-Cheng (TW); Yi-Chien Chen, Tu-Cheng (TW); Chen-Yu Chen, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/075,133

(22) Filed: Mar. 8, 2005

(30) Foreign Application Priority Data
Mar. 20, 2004 (CN) 200410026611.X

(51) Int. Cl. G06F 15/16; G06F 15/173

(52) U.S. Cl. 709/218; 709/224

(57) ABSTRACT

A system for graphically managing network devices includes a web browser (1100); a web server (1200) connected between the web browser and network devices including a first HTML page (1210) and a device front-panel picture (200); and a GDM (Graphical Device Manager, 1211) which is a Java applet, embedded in the first HTML page. The GDM comprises a GDM object (1212), an Image List object (1213), an LED object (1214), a Status object (1215) and a Port Connector object (1216). The GDM initializes itself according to a second HTML page (1220) and a third HTML page (1230). The GDM generates pictures of all ports (201) and LEDs (203, 204, 205, 206, 207, and 208) based on the working statuses. The GDM is operated via a multi-thread cluster, and a user can click the Mode button (202) and the ports (201) in order to manage the network devices. A related method for graphically managing network devices is also provided.

### BACKGROUND OF THE INVENTION

1. Field of the Invention

The present invention relates to systems and methods for graphically managing network devices, and particularly relates to a system and method for managing network devices by using of a plurality of ports and pictures of LEDs (Light Emitting Diodes) that represent the ports.

2. Prior Art

With the fast development and widespread application of communication networks, it is becoming more and more important to efficiently and effectively manage network devices employed in the communication field. Most network devices such as switches, routers, hubs, etc. use a control panel, a standard terminal, and a Telnet function for configuring, monitoring and controlling. The application of a GUI (Graphical User Interface) or a CLI (Command Line Interface) is quite popular for managing network devices.

The CLI exists in the DOS (Disk Operating System) environment, which is operated by a user entering key words or other parameters letter by letter. However, the DOS environment is widely perceived as being inconvenient and user-unfriendly for selecting and entering related commands to implement the interaction between client sites and web servers, the CLI is considered to be rather complicated and difficult to use in managing network devices.

The GUI is one kind of graphical software application for managing network devices. The GUI is based on one or several pattern control windows such as menus, tables, and activity bars to execute commands. The advantage of the GUI is its simple maneuverability. Its most important benefit is that the user can input configuration commands to operate a system without reciting any command employed by a CLI. In addition, appropriate graphic icons in the GUI can help the user to understand and search relevant functions more quickly. When the user runs the system, he/she can intuitively use the various functions of the system without having to learn more new operational skills. Therefore, the GUI has become the major communication interface between users and network devices.

However, systems for managing the network devices generally still use the complex command line mode. There is a need for an improved system and method which graphically manages the network devices.

### SUMMARY OF THE INVENTION

A first objective of the present invention is to provide a system for graphically managing network devices, including monitoring, configuring and controlling of switches, routers and other network devices from a remote client site.

A second objective of the present invention is to provide a method for graphically managing network devices, including monitoring, configuring and controlling of switches, routers and other network devices from a remote client site.

In order to fulfill the above-mentioned first objective, the present invention provides a system for graphically managing the network devices via an HTML (Hypertext Markup Language) page. The system comprises: a web browser for inputting and receiving a message; a web server connected between the web browser and network devices including a first HTML page and a device front-panel picture; and a GDM (Graphical Device Manager) which is a Java applet, embedded in the first HTML page. The GDM comprises a GDM object, an Image List object, an LED object, a Status object and a Port Connector object. The GDM initializes itself according to a second HTML page and a third HTML page. The GDM generates pictures of all ports and LEDs based on the working statuses. The GDM is operated via a multi-thread cluster, and a user can click the Mode button and the ports in order to manage the network devices.

In order to fulfill the above-mentioned second objective, a method for graphical device management of network devices is provided. The method includes the steps of: opening a first HTML page via a web browser; loading a first parameter and a second parameter to a GDM; initializing the GDM; retrieving initial statuses of ports and LEDs of network devices from a web server according to the second parameter; generating a picture of each port and a picture of each LED on a device front-panel picture according to the initial statuses thereof; retrieving working status of the ports and LEDs of the network devices from the web server according to the second parameter periodically; and regenerating as necessary the picture of each port and the picture of each LED on the device front-panel picture according to current statuses thereof.

Other objects, advantages and novel features of the present invention will become more apparent from the following detailed description when taken in conjunction with the accompanying drawings, in which:

### BRIEF DESCRIPTION OF THE DRAWINGS

FIG. 1 is a block diagram of a system for graphical device management according to a preferred embodiment of the present invention;

FIG. 2 illustrates an exemplary device front-panel picture according to the preferred embodiment of the present invention;

FIG. 3A illustrates various port status pictures and LED status pictures which are used in the device front-panel picture of FIG. 2;

FIG. 3B is an explanatory table of various LED displays and their corresponding meanings, with respect to each of three different modes under which the LED status pictures of FIG. 2 may be operating;

FIG. 4 is an explanatory table of various LED displays and their corresponding meanings, with respect to each of two different power status pictures of FIG. 2;

FIG. 5 is a flow chart of a preferred method for graphical device management of network devices according to the present invention;

FIG. 6 is a flow chart of one of steps of FIG. 5, namely initializing a GDM; and

FIG. 7 is a flow chart of possible responses of a GDM of the system of FIG. 1 to a mouse click event.

### DETAILED DESCRIPTION OF THE INVENTION

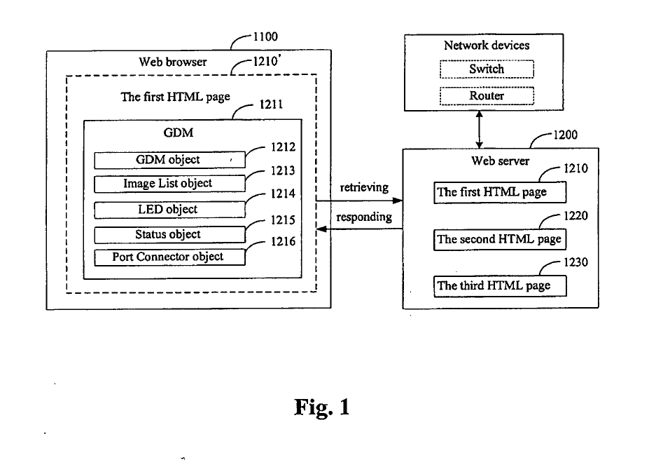

FIG. 1 is a block diagram of a system for graphically managing network devices according to the preferred embodiment of the present invention. A web browser 1100 is an interface between users and the network devices, which allows each user to read/write messages to a web server 1200. The web server 1200 comprises a plurality of HTML (Hypertext Markup Language) pages. In the preferred embodiment of the present invention, there are three HTML pages respectively named as a first HTML page 1210, a second HTML page 1220 and a third HTML page 1230. A GDM (Graphical Device Manager) 1211 is embedded in the first HTML page 1210. The user opens the first HTML page 1210 (e.g., “status-page.htm”), and then the GDM 1211 is loaded automatically from the web server 1200 to the web browser 1100. The GDM 1211 is a Java applet program, which comprises five major objects such as a GDM object 1212, an Image List object 1213, an LED object 1214, a Status object 1215 and a Port Connector object 1216.

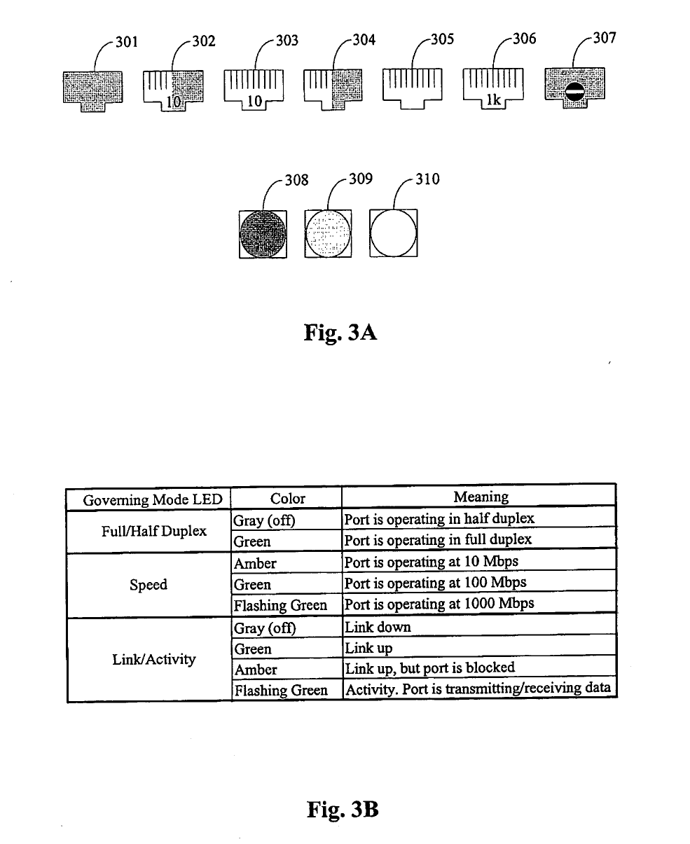

The GDM object 1212 is a main object for activating, stopping, and operating the GDM 1211, and setting statuses and creating other objects. The Image List object 1213 stores a plurality of port status pictures and a plurality of LED pictures. The LED pictures can be treated as an array of small images (see FIG. 3A) which clearly represent the working statuses of the network devices. The LED object 1214 represents different working statuses by generating different LED pictures. The Status object 1215 contains the number of network devices, the model type and other similar information on the network devices, and all port and LED statuses of the network devices. The Port Connector object 1216 generates port status pictures which represent working statuses of the ports.

After being opened, the first HTML page 1210 loads a first parameter and a second parameter to the GDM 1211 for constructing information. The first parameter and the second parameter are Java applet programs. The first parameter is a URL (Uniform Resource Locator) of the second HTML page 1220 which contains a data structure of construction information, such as the URL of a device front-panel picture, the number of ports, the coordinates of ports and LEDs, and the URLs of image icons, etc. The second parameter is a URL of the third HTML page 1230 which contains a data structure of current statuses of the network devices.

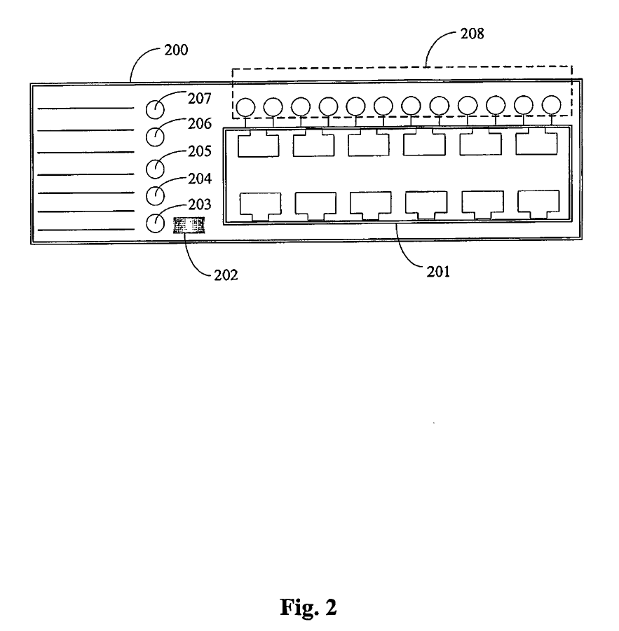

According to the first parameter and the second parameter, the GDM 1211 initializes itself and loads a device front-panel picture 200, as shown in FIG. 2. The device front-panel picture 200 includes a plurality of ports 201 (RJ45 type), a plurality of Port LEDs 208, a plurality of Mode LEDs 203, 204, 205, two Power Status LEDs 206 and 207, and a Mode button 202. The Mode LED 203 is an indicator of a Full/Half Duplex mode, the Mode LED 204 is an indicator of a Speed mode, and the Mode LED 205 is an indicator of a Link/Activity mode. The Power Status LED 206 is an indicator of an RPS (Redundant Power System) status, and the Power Status LED 207 is an indicator of a main power status. The user clicks on the Mode button 202 with a computer mouse to select a mode for monitoring the status of ports, whereupon LEDs with different colors are displayed. The selected mode may be the Full/Half Duplex mode, the Speed mode, or the Link/Activity mode.

In accordance with the preferred embodiment of the present invention, the system provides three LED status pictures for aiding the user to monitor and configure the network devices. Referring to FIG. 3A, an image array of three LED status pictures comprises a first LED status picture 308, a second LED status picture 309 and a third LED status picture 310, for indicating various working statuses of network devices with different colors displayed in different modes. For example, the first LED status picture 308 is defined in green, the second LED status picture 309 is defined in amber, and the third LED status picture 310 is defined in gray which represents the LED being off.

Referring to FIG. 3B, when the Full/Half Duplex mode is selected, if the LED 203 is displayed in green, this means the port is operating in full duplex. If the LED 203 is displayed in amber, this means the port is operating in half duplex. When the LED 203 is displayed in green, this is achieved by the first LED status picture 308 being chosen from the image array. When the LED 203 is displayed in amber, this is achieved by the second LED status picture 309 being chosen from the image array.

When the Speed mode is selected, if the LED 204 is displayed in green, this means the data transmission rate of the corresponding port is 10 Mbps (Megabytes per second). If the LED 204 is displayed in amber, this means the data transmission rate is 100 Mbps. If the LED 204 is displayed in flashing green, this means the data transmission rate is 1000 Mbps.

When the Link/Activity mode is selected, if the LED 205 is displayed in green, this means the connection to the relevant network device is linking up. If the LED 205 is displayed in amber, this means the connection is linking up but the corresponding port is blocked. If the LED 205 is displayed in flashing green, this means the connection is linking up and the port is transmitting or receiving data. If the connection is not linking, the LED 205 is displayed in gray (off).

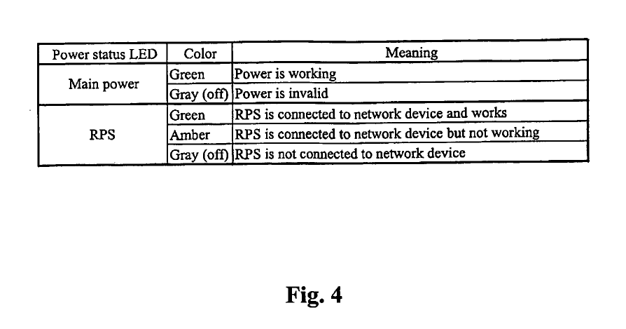

The Power Status LED 206 and the Power Status LED 207 indicate various power statuses of the network devices. Referring to FIG. 4, the Power Status LED 207 displayed in green means the main power of the relevant network device is working, and the Power Status LED 207 displayed in gray (off) means the main power is invalid. If the Power Status LED 206 is displayed in green, the RPS of the network device is working as normal. If the RPS is connected to the network devices but is not working, the Power Status LED 206 is displayed in amber. If the RPS is not connected to the network device, the Power Status LED 206 is displayed in gray (off).

Referring to FIG. 3A, in accordance with the preferred embodiment of the present invention, the GDM 1211 comprises seven RJ45 type pictures to represent data transmission rates and working statuses of the corresponding ports of the network devices. The port status picture 301 means the port is idle, the port status picture 302 means the data transmission rate is 10 Mbps in the half duplex mode, the port status picture 303 means the data transmission rate is 10 Mbps in the full duplex mode, the port status picture 304 means the data transmission rate is 100 Mbps in the half duplex mode, the port status picture 305 means the data transmission rate is 10 Mbps in the half duplex mode, the port status picture 306 means the data transmission rate is 1000 Mbps in the full duplex mode, and the port status picture 307 means the port is blocked.

In the preferred embodiment of the present invention, a multi-thread cluster is provided to perform the GDM 1211. The multi-thread cluster is a computer readable medium encoded with Java executable instructions. The multi-threaded cluster comprises a first thread, a second thread, and a third thread. The first thread is provided for initializing the GDM 1211, and for creating the second thread and the third thread. The second thread requests the construction information to the web server 1200, and retrieves the device front-panel picture 200 and a working status on each port and each LED. The construction information is a data structure of a Java program, which is embedded in the second HTML page 1220. The second thread constructs the number of objects according to the construction information. The third thread generates all pictures of LEDs according to the retrieved working statuses in the GDM 1211, especially the flashing LEDs. After the second thread has constructed all the objects, the first thread generates most of the pictures, except the flashing LED pictures which are processed by the third thread.

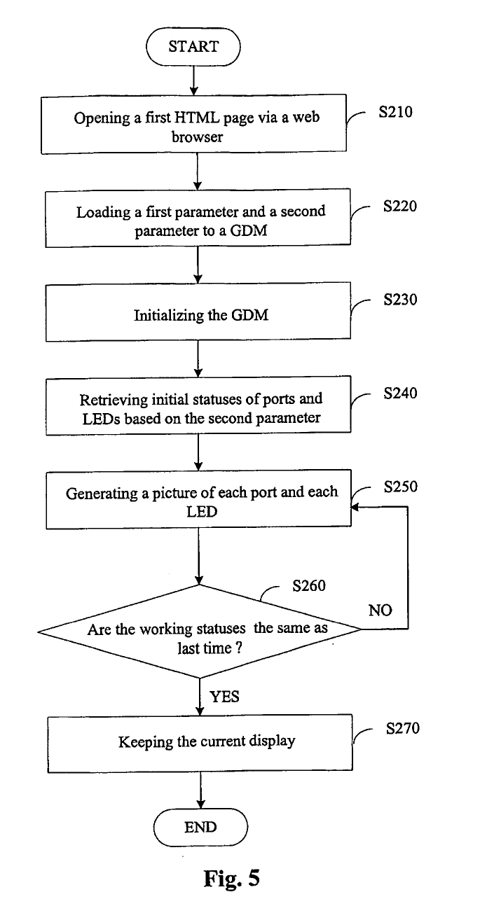

FIG. 5 is a flow chart of a preferred method for graphically managing network devices in accordance with the present invention. At step S210, the user opens the first HTML page 1210 via the web browser 1100. At step S220, the web browser 1100 loads the first parameter and the second parameter to a GDM 1211. At step S230, the GDM 1211 initializes itself. At step S240, the GDM 1211 retrieves the initial statuses of the ports and the LEDs of the network devices from the web server 1200 based on the second parameter that is the URL of the third HTML page 1230. At step S250, the GDM 1211 generates a picture of each port and each LED on the device front-panel picture 200. At step S260, the GDM 1211 retrieves the working statuses of the ports and the LEDs of the network devices from the web server 1200 according to the second parameter periodically, and determines whether any of the working statuses has changed. In the preferred embodiment, the frequency of retrieval is every 5 seconds. At step S270, the GDM 1211 keeps the current display of the device front-panel picture 200 if the working status stays the same; otherwise, the procedure goes back to step S250.

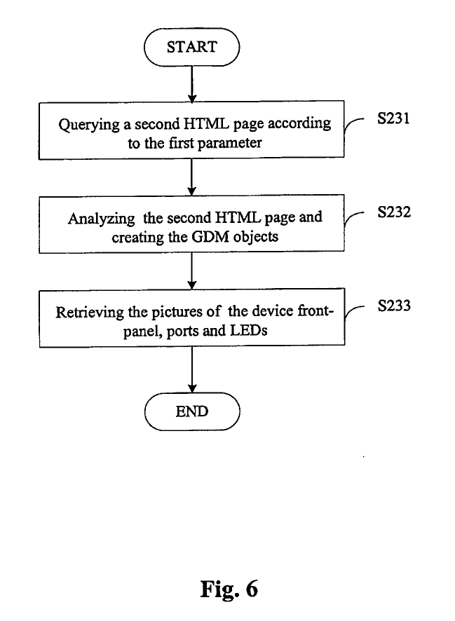

FIG. 6 is a flowchart of details of step S230 of FIG. 5, namely initializing the GDM 1211. At step S231, the GDM 1211 queries to the web server 1200 for the second HTML page 1220 according to the first parameter. At step S232, the GDM 1211 analyzes the second HTML page 1220 to create the five objects 1212-1216 mentioned above. At step S233, the GDM 1211 retrieves the pictures of the device front-panel 200, the ports 201 and the LEDs 203, 204, 205, 206, 207 and 208 from the web server 1200.

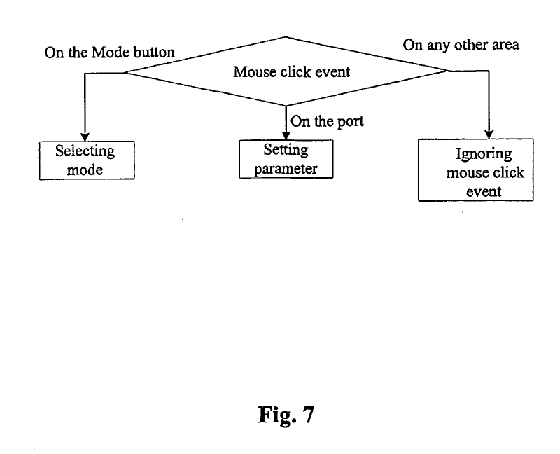

In accordance with the preferred embodiment of the prevent invention, the GDM 1211 is not only for monitoring but also configuring and controlling the network devices by parameter setting from the remote client site. Referring particularly to FIGS. 2 and 7, after accomplishing the step of initializing the GDM 1211, the user can monitor, configure and control the network devices by operating upon the device front-panel picture 200. The first thread is programmed for accessing a mouse click event whereby the working status could be changed. When the user clicks the mouse to send a mouse click event to the web server 1200 via the web browser 1100, the GDM 1211 comprises the following three different responses: (1) when the user clicks on the Mode button 202, each Mode LED 203, 204, and 205 on the device front-panel picture 200 displays different statuses according to the particular mode selected; (2) when the user clicks on each picture of a port, the GDM 1211 pops up a new browser (not shown) for setting parameters to configure or control the port; (3) when the user clicks on any other area, the GDM 1211 ignores the mouse click event.

While preferred embodiments and methods of the present invention have been described above, it should be understood that they have been presented by way of example only and not by way of limitation. Thus the breadth and scope of the present invention should not be limited by the above exemplary embodiments and methods, but should be defined only in accordance with the following claims and their equivalents.

1. A system for graphically managing network devices, comprising:
a web browser for a user to input and receive a message;
a web server connected between the web browser and the network devices, comprising a first HTML (Hypertext Markup Language) page and a device front-panel picture; and
a GDM (Graphical Device Manager), which is a computer readable medium encoded with a Java applet embedded in the first HTML page.

2. The system according to claim 1, wherein the device front-panel picture comprises a plurality of port status pictures.

3. The system according to claim 1, wherein the device front-panel picture comprises a plurality of LED (Light Emitting Diode) pictures.

4. The system according to claim 3, wherein the plurality of LED pictures comprises a plurality of Port LED pictures, a plurality of Mode LED pictures, and a plurality of Power Status LED pictures.

5. The system according to claim 1, wherein the device front-panel picture comprises a Mode button picture.

6. The system according to claim 1, wherein the GDM comprises:
a GDM object for starting, stopping, and operating the GDM, and setting statuses and creating other objects;
an Image List object for storing a plurality of port status pictures and a plurality of LED pictures;
an LED object for representing different working statuses by generating different LED pictures;
a Status object including the number of network devices, the model type of the network devices, and each port and each LED of the network devices; and
a Port Connector object for generating port status pictures which represent working statuses of the ports.

7. The system according to claim 1, wherein the web server comprises a second HTML page and a third HTML page for the initializing the GDM.

8. The system according to claim 7, wherein the first HTML page further comprises:
a first parameter that is a URL (Uniform Resource Locator) of the second HTML page; and
a second parameter that is a URL of the third HTML page.

9. The system according to claim 1, further comprising a multi-thread cluster to perform the GDM, wherein the multi-thread cluster is a computer readable medium encoded with a set of executable instructions.

10. The system according to claim 1, wherein the GDM comprises a Full/Half Duplex Mode, a Speed Mode, a Link/Activity Mode, a main Power Status Mode, and an RPS (Redundant Power System) Power Status Mode.

11. A method for graphical device management of network devices, comprising the steps of:
opening a first HTML (Hypertext Markup Language) page via a web browser;
loading a first parameter and a second parameter to a GDM (Graphical Device Manager);
initializing the GDM;
retrieving initial statuses of ports and LEDs (Light Emitting Diodes) of network devices from a web server according to the second parameter;
generating a picture of each port and a picture of each LED on a device front-panel picture according to the initial statuses thereof;
retrieving working status of the ports and LEDs of the network devices from the web server according to the second parameter periodically; and
regenerating as necessary the picture of each port and the picture of each LED on the device front-panel picture according to current statuses thereof.

12. The method according to claim 11, wherein the step of initializing the GDM comprises the steps of:
querying a second HTML page to the web server according to the first parameter;
analyzing the content of the HTML page to create GDM objects; and
retrieving pictures of the device front-panel, a plurality of ports and a plurality of LEDs.

13. A method for management of network devices, comprising the steps of:
initializing a graphical device manager (GDM) of a hypertext markup language (HTML) page via a web browser;
retrieving status information of connection ports and light emitting diodes (LEDs) of said network devices;
graphically presenting said ports and said LEDs by means of said GDM and said HTML page via said web browser; and
graphically presenting said status information of said ports and said LEDs at corresponding graphic presentations of said ports and said LEDs via said web browser by means of said GDM.

14. The method according to claim 13, wherein GDM objects are created to generate said corresponding graphic presentations of said ports and said LEDs by means of said GDM in the step of initializing said GDM.

15. The method according to claim 13, wherein a mode button of said network devices is graphically presented in the step of graphically presenting said ports and said LEDs, and corresponding graphic presentations of said mode button and said ports are exclusively and selectively mouse-clickable for further management of said network devices via said web browser.
